(19) United States
(12) Patent Application Publication
(10) Pub. No.: US 2007/0205301 A1
(43) Pub. Date: Sep. 6, 2007

(54) Motion activated irrigator

(76) Inventor: Gerard Dennis Slack, Van Horn, TX (US)

Correspondence Address: GERARD D. SLACK, POST OFFICE BOX 761, VAN HORN, TX, 79855-0761, US

(21) Appl. No.: 11/367,528

(22) Filed: Mar. 3, 2006

(51) Int. Cl. A01G 27/00

(52) U.S. Cl. 239/67

(57) ABSTRACT

For purposes of description the machine is not enclosed in a secure box but may easily be. It may also be located remotely so as to make it not noticable. This irrigation machine has different modern parts so as to make it desirable for many uses. It is best adapted to agriculture. It is a deduction of many previously available elements. This irrigator is versatile as it can be driven electrically by supplied electrical service or battery but also by propane gas that is self-contained remotely for power. This machine can be motion activated, or remotely activated as it is presently configured. It does not have sound aparatus but could be adapted to sound. Propane gas would need to provide electricity by form of an additional generater to the mechanism. My invention is not currently rigged with propane. The machine's size makes it adaptable to remote capabilities. The machine's application can also extend to residences, commercially by means of landscaping, sports facilities, swimming pools, and the like.

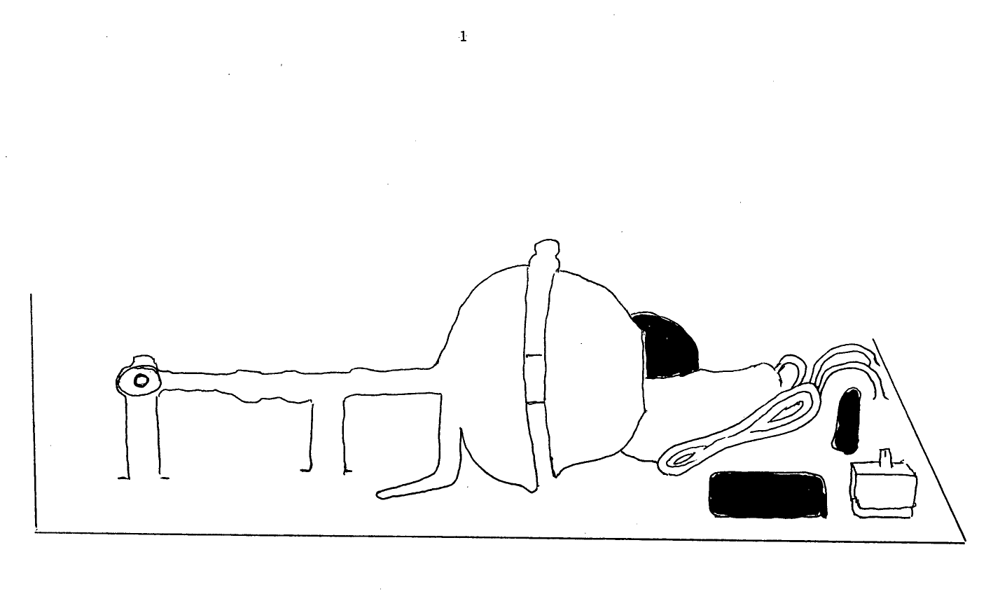

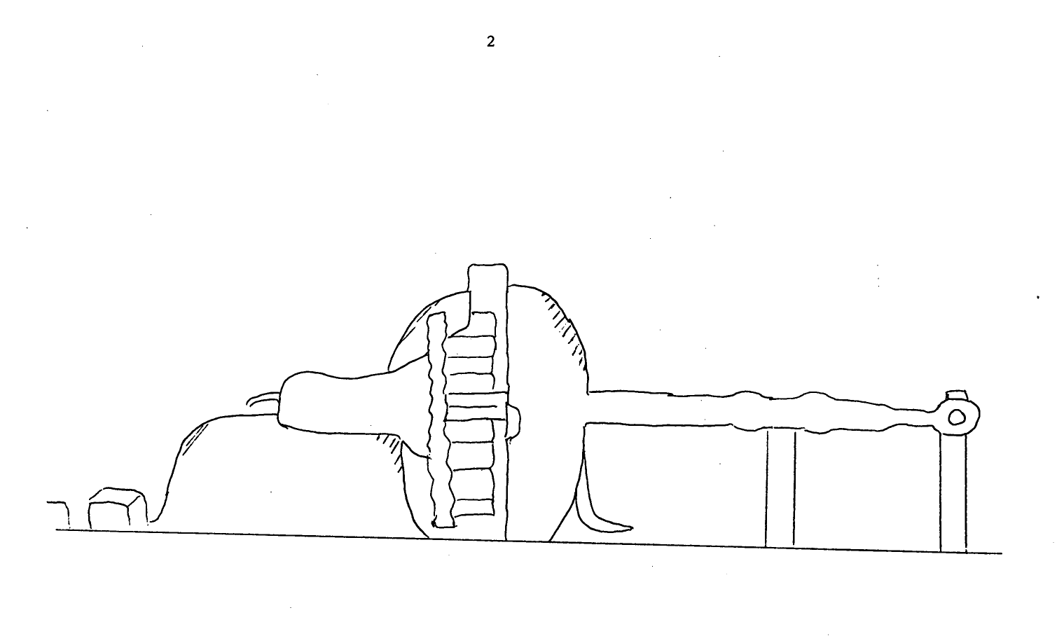

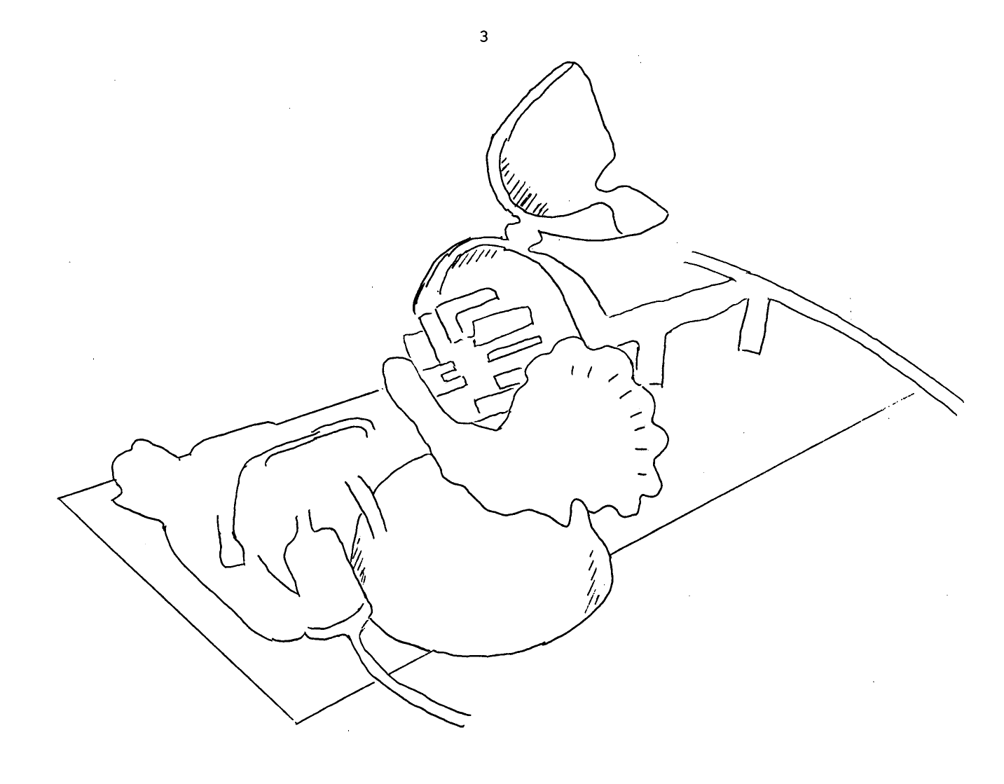

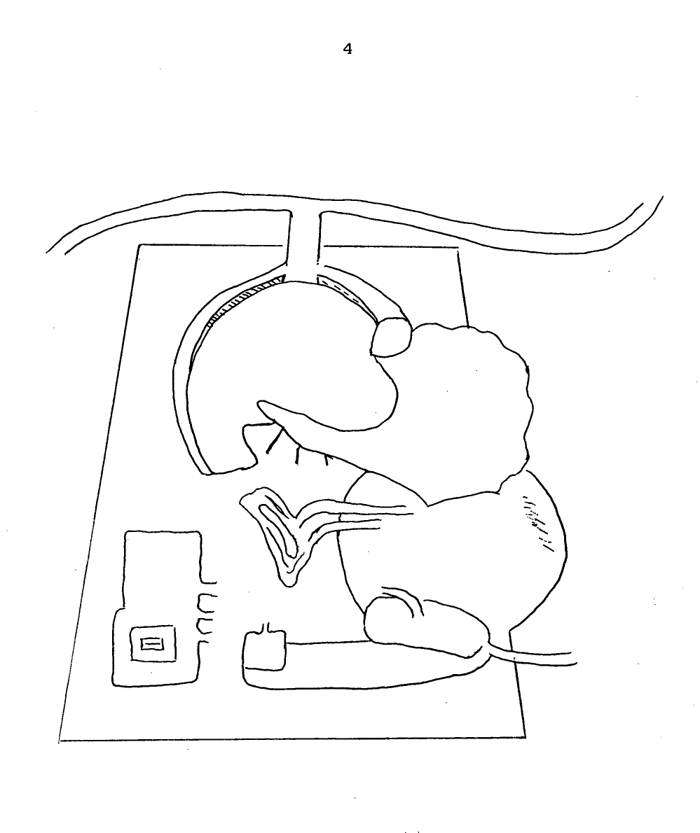

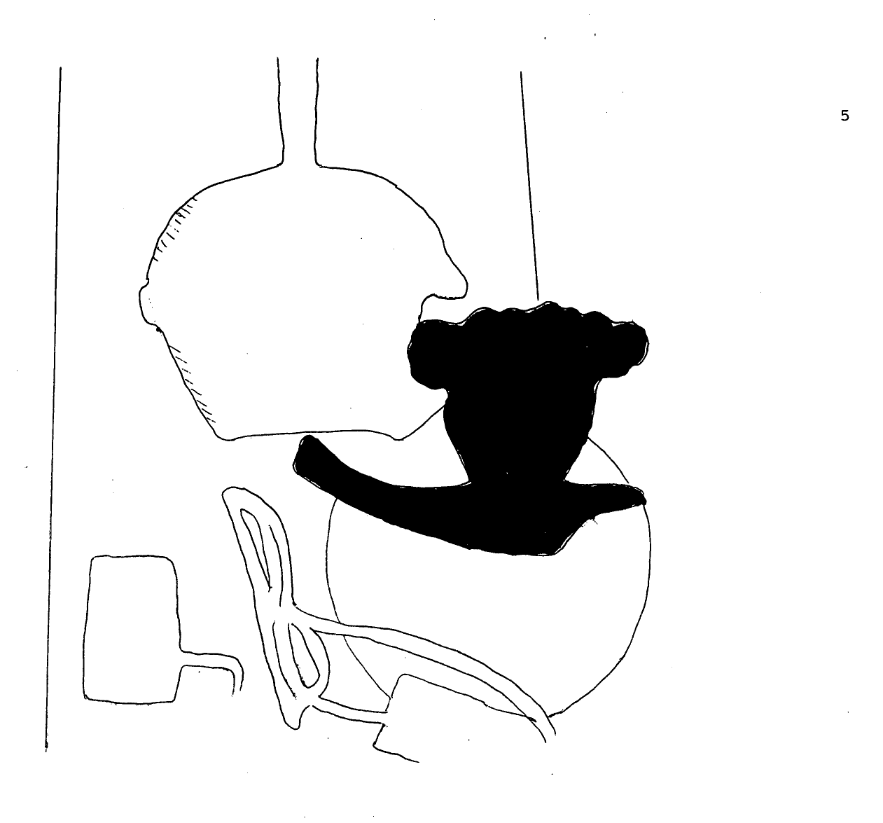

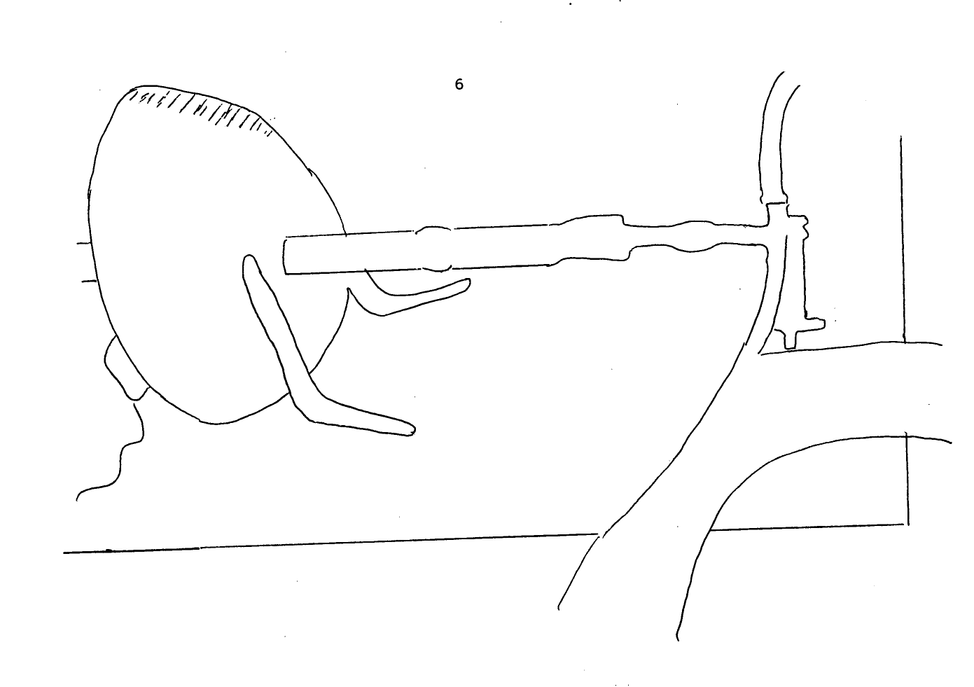

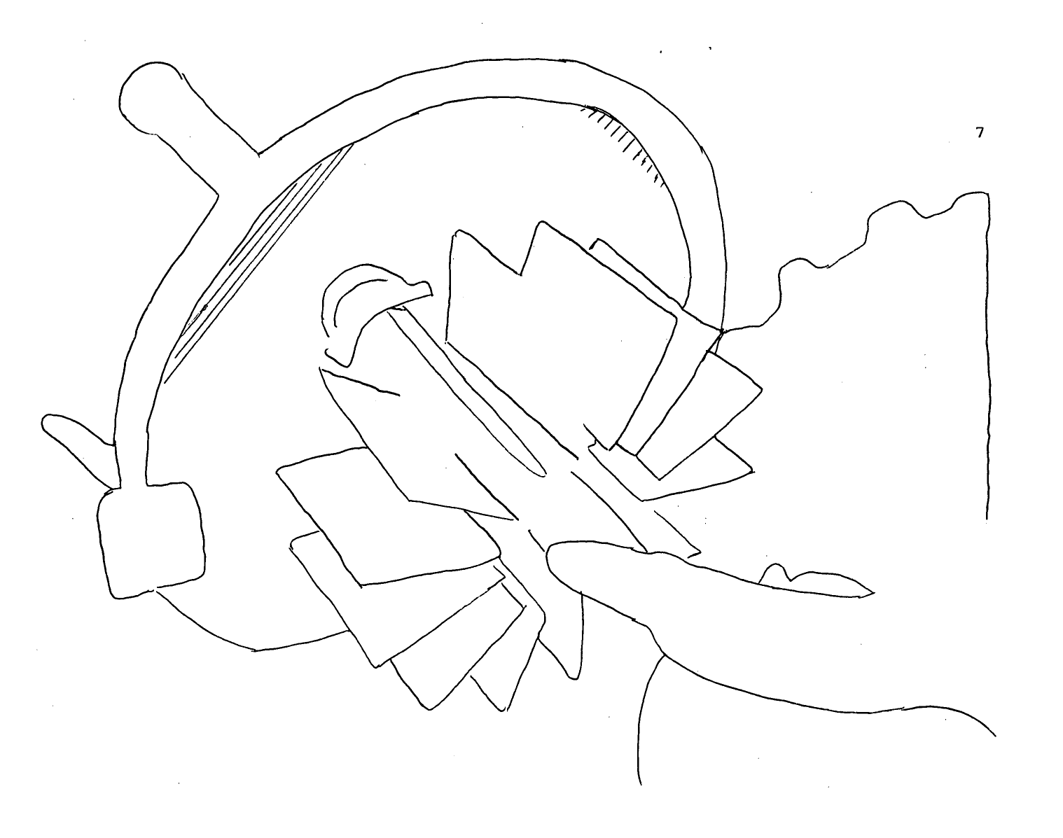

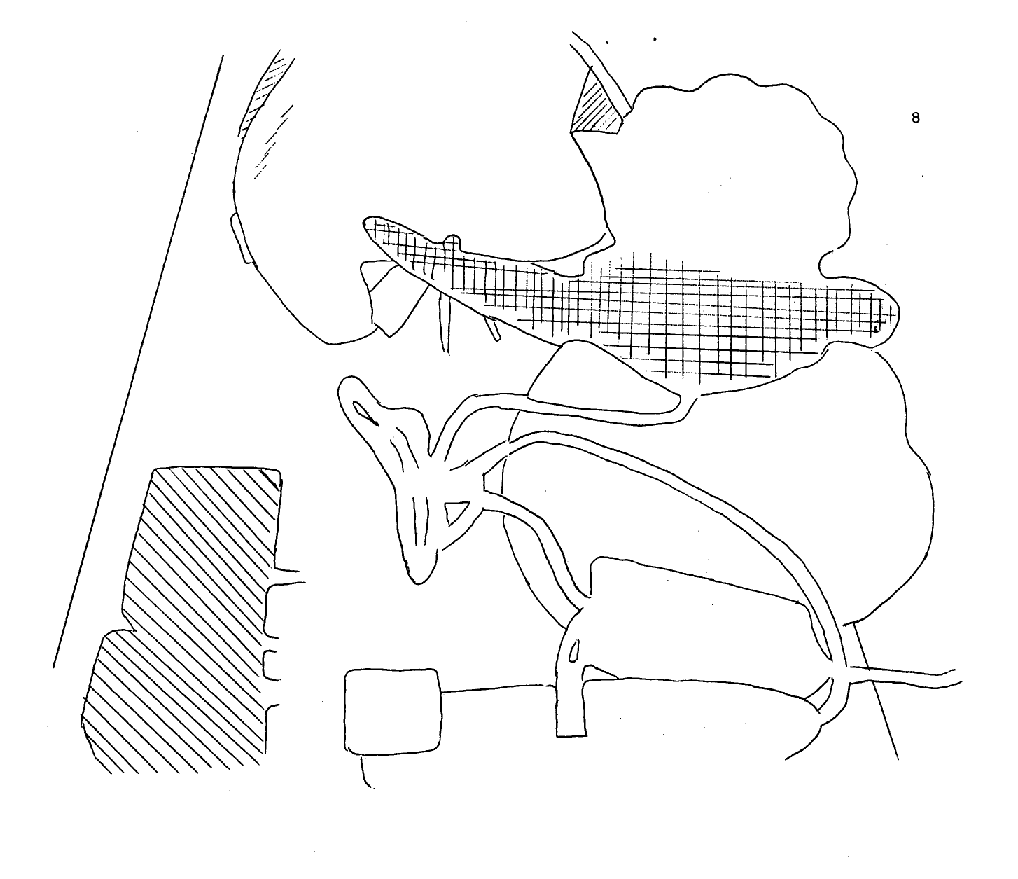

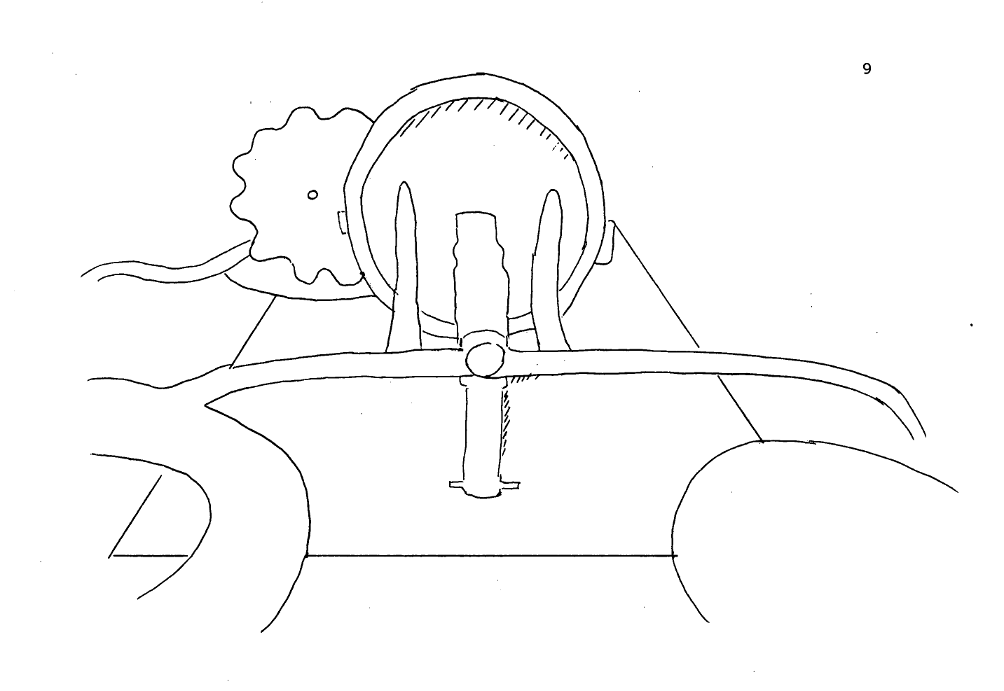

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF INVENTION

The machine I have invented is an irrigator. The machine's main area of application is in agriculture. The motion activated irrigator seeks to follow the trend in modern systems to irrigate at ground level or at a desirable location and not necessarily be puting water or other fluid in the air. This is helping to conserve water.

This machine can be integrated with other systems. It is also of automatic design and is desirable where manual systems are not needed or wanted. This machine may also be used indoors and utilizes existing water pressure without additional pumps.

### BRIEF SUMMARY OF THE INVENTION

This machine is of original design and uses a motion sensor to activate other moving parts. Its purpose is to start or stop water or other fluid to irrigate. It is presently arranged with a garden hose. This machine has been tested and functions as expected. It is made of light weight components and may be used in a compact space.

### BRIEF DESCRIPTION OF THE SEVERAL VIEWS OF THE DRAWINGS

1 Left side cross section

2 Right side cross section

3 Alternate position perspective

4 Additional perspective

5 Bottom view is not applicable

6 FIG. A Top view elevation

6 FIG. B Additional right view plan showing water valve

6 FIG. C Additional alternate position of interior mechanism

6 FIG. D Additional perspective of machine parts

6 FIG. E Additional perspective showing connection to water valve

### OBJECT PARTS OF MACHINE INVENTION ARE:

1 Motion sensor and its connection

2 Remote on and off switch

3 Electric power cords

4 Electric motor

5 Motor mount

6 Machine protective cover

7 Machine to turn shaft

8 Pvc pipe used as shaft

9 Water valve

10 Garden hose

11 Board with machine attached

12 Mounting equipment

13 Hinge tool normally closed

The drawings are original but based on photographs which I have included. I request these photographs be returned by the uspto.

### DETAILED DESCRIPTION OF THE INVENTION

The motion activated irrigator is a machine mounted on a wooden board that is 22 inches wide, 48 inches long, and 15 inches in height. All of its-parts are attached to its board. Some of its equipment extend beyond its width and length. This machine has pvc light weight plastic pipe mounted to hold a water valve with an intake and out fassioned garden hose. The water valve is open and shut by another pvc pipe used as a shaft and connected to a part of the machine similar to a small fan. The shaft is turned by a motor. The motor's power cord is connected to a power cord with an on and off switch. This gives the machine capability as its power is connected to other functional parts that are a motion sensor and a remote on and off switch. Thus, the machine is motion activated.

It is because the machine uses a garden hose to its water valve, it may be placed at a convenient location connected to water lines and turned on remotely or by local motion by process of its motion sensor.

Previous irrigation systems are not necessarily automatic but this machine is and can also be adapted to sound. This machine presently uses electricity as power and is not a large machine but is capable of automatically starting or stopping as often as necessary water flow. It may also use fluid other than water.

1. I Gerard D Slack a citizen of the United States of America claim to be the sole inventor of the motion activated irrigator as shown and described in drawings included with this claim. It is not a way of doing business but a practical mechanism utilizing modern parts to accomplish tasks not previously evident through a single machine. The machine irrigates automatically in a manner not before known so thusly can be adapted to current systems already in use.
